(19) United States
(12) Patent Application Publication
(10) Pub. No.: US 2026/0273541 A1
(43) Pub. Date: Sep. 17, 2026

(54) SPIRAL JET MILL WITH MULTIPLE PRODUCT INJECTOR NOZZLES AND METHOD OF MILLING A GRANULAR PRODUCT

(71) Applicant: KRONOS INTERNATIONAL, INC., Leverkusen (DE)

(72) Inventors: Jörg FRIEDRICH, Leichlingen (DE); Martin SANDROCK, Essen (DE)

(73) Assignee: KRONOS INTERNATIONAL, INC., Leverkusen (DE)

(21) Appl. No.: 19/471,750

(22) PCT Filed: Apr. 3, 2024
(86) PCT No.: PCT/EP2024/059101

§ 371 Date: Oct. 2, 2025

(30) Foreign Application Priority Data
Apr. 5, 2023 (EP) 23166851.8

(51) Int. Cl. B02C 19/06

(52) U.S. Cl. CPC B02C 19/063

(57) ABSTRACT

A spiral jet mill for grinding granular product, such as TiO2 particles, includes multiple, such as at least two product injector nozzles for mixing and injecting a corresponding number of streams of steam or other pressurized gas and the granular product into the grinding chamber. In use, the ratio of total pressurized gas, such as the sum of all input steam and grinding steam injected into the grinding chamber, to granular product, such as TiO2 pigment particles, is preferably less than the corresponding ratio used in conventional processes so as to realize energy savings relative to the amount of steam or other pressurized gas that is used per unit of granular product that is milled.

### BACKGROUND

Spiral jet mills are used for grinding granular materials, for example the comminution of powdery materials, to reduce the particle sizes of the granular material. A conventional spiral jet mill includes a generally planar, circular grinding chamber that is surrounded by a manifold with a number of grinding steam injectors that inject grinding steam into the grinding chamber. Typically, each of the grinding steam injectors is oriented at the same angle to radial, that is, tangentially to the centerline, so as to promote relatively uniform flow either clockwise or counterclockwise around the grinding chamber. A lid covers the top end of the grinding chamber and includes a single product injector nozzle, which is used to inject a stream of mixed input steam and the granular product into the grinding chamber. The product injector nozzle is typically oriented tangentially to the centerline and at an acute angle relative to the horizontal so as to inject the stream of product and input steam along the same clockwise or counterclockwise direction as the grinding steam. As the granular particles whirl around the outer periphery of the grinding chamber, impacts with the grinding steam eventually comminute the granular particles. The smaller, milled particles eventually migrate to the center of the grinding chamber, where an exhaust outlet allows the milled particles to be ejected from the grinding chamber with the exhaust steam. An example of a conventional spiral jet mill may be seen in U.S. Pat. No. 7,150,421.

Spiral jet mills that rely on steam as the input gas and/or grinding gas can use a large amount of steam, and thus energy, to mill a given amount of granular product. Therefore, it would be desirable to improve on the efficiency of the conventional spiral jet mill to reduce input costs and/or to have a lower carbon footprint to be more ecologically friendly.

### SUMMARY OF THE INVENTION

In one aspect of the invention, a spiral jet mill includes a manifold surrounding and at least partly defining a grinding chamber, a grind gas injector port extending through the manifold into the grinding chamber for injecting grinding material into the grinding chamber, a cover over the manifold, the cover at least partly defining the grinding chamber, and an exhaust port for exhausting ground product from the grinding chamber. A first product injector nozzle is directed into the grinding chamber and configured to mix and inject a first stream of input gas and a granular product into the grinding chamber, and a second product injector nozzle is directed into the grinding chamber for mixing and injecting a second stream of input gas and the granular product into the grinding chamber.

Any one or more of the product injector nozzles may extend through the cover. For example the first product injector nozzle may extend through the lid and the second injector nozzle may extend through another portion of the spiral jet mill, such as through a bottom wall of the grinding chamber and/or through the manifold. Preferably, at least each of the first and second product injector nozzles extends through the cover. Optional additional product injector nozzles may similarly extend through the lid or through another portion of the spiral jet mill as long as they are configured to inject a stream of the product into the grinding chamber to be milled by the grinding material therein.

In some optional configurations, the spiral jet mill may include more than two product injector nozzles. For example, the spiral jet mill may optionally include a third product injector nozzle extending through the cover for mixing and injecting a third stream of steam and the granular product into the grinding chamber. In other optional configurations, the spiral jet mill may include four, five, six, seven, eight, or really any number of product injector nozzles capable of fitting into the physical space available.

The product injector nozzles may be aligned in any manner suitable for injecting product into the grinding chamber to allow for grinding of the product. Some optional configurations are described hereinafter. For example, any or all of the product injector nozzles may be aligned tangentially to and offset from a centerline of the grinding chamber. Any one or more of the product injector nozzles may be aligned to inject the respective streams in the same clockwise or counterclockwise direction around the grinding chamber. The first and second product injector nozzles may be disposed on opposite sides of the centerline, for example on the same diameter through the centerline.

The product injector nozzles may be aligned in parallel sets, such as in parallel pairs. For example, the first product injector nozzle may be aligned parallel to the second product injector nozzle, for example in parallel vertical planes that are equidistant from and on opposite sides of the center line of the grinding chamber. Where there are four, six, or other multiples of pairs of product injector nozzles, two or more of the pairs may be aligned parallel with each other, for example, in parallel vertical planes with each pair being angularly offset around the circumference of the grinding chamber from one or more of the other pairs.

Any one or more of the product injector nozzles may have an injection end disposed inside the grinding chamber so as to inject product directly into the grinding chamber. In some arrangements, the injection end of two or more of the product injector nozzles may be located the same radial distance from the centerline.

The manifold may take any form suitable for injecting the grinding material into the grinding chamber. For example, the manifold may include a plurality of grind gas injector ports extending through the manifold into the grinding chamber for injecting grinding material into the grinding chamber. In some configurations, the manifold may include between one and thirty grind gas injector ports, although any number capable of physically fitting in the manifold could be used. Preferably, some or all of the grind gas injector ports are aligned tangentially rather than radially through the centerline so as cause gases and product inside the grinding chamber to swirl in a single clockwise or counterclockwise direction. In some arrangements, all the grind gas injector ports and the product injector nozzles may be tangentially aligned in the same general clockwise or counterclockwise orientation to promote uniform circumferential flow of gases and product inside the grinding chamber. However, in other arrangements, one or more of the grind gas injector ports and the product injector nozzles may be oriented in other orientations, for example in opposite clockwise/counterclockwise directions, radially, or tangential to different radius circles or other arcs, to increase turbulence and/or promote different flow patterns inside the grinding chamber.

The product injector nozzles may take any suitable form for injecting a stream of a mixture of the product to be ground and a pressurized gas. In some arrangements, any one or more of the product injector nozzles may have a primary entry port for gas and product and one or more secondary entry ports for adding one or more dosing substances or other materials into the stream. In one example, the primary entry port and the secondary entry port may converge at and/or otherwise connect to a mixing chamber where product from the secondary entry port(s) mixes with the stream of product and pressurized input gas(es). A passageway may extend from the mixing chamber into the grinding chamber to inject the mixed stream into grinding chamber. However, the inclusion of a secondary entry port is not necessary and may be omitted or any number of secondary entry ports may be provided.

In another aspect of the invention, a method of milling a granular product using a steam jet mill as disclosed herein is provided. The method includes the steps of simultaneously injecting first stream of a mixture of input gas and granular product into the grinding chamber through the first product injector nozzle and injecting second stream of a mixture of input gas and granular product into the grinding chamber through the second product injector nozzle. The grinding material is injected into the grinding chamber through the grind gas injector port so as to impact and mill the granular product from the first and second streams into smaller particle sizes.

The spiral jet mill may be operated with essentially any type of pressurized gas, such as, steam, air, nitrogen, or similar gases, and combinations thereof. Preferably, the pressurized gas(es) is/are inert and/or inflammable, although some applications may use flammable or otherwise reactive gases. In some arrangements, the input gas and/or the grinding material may be or include pressurized gas, for example, steam, air, and/or nitrogen.

It is contemplated that the spiral jet mill may be used to grind and reduce the size(s) of particles of granular material of almost any substance. For example, the granular product may be and/or include TiO2 (titanium dioxide) pigment particles having particles sizes between approximately 0.1 μm and 5 cm. However, other types of granular product and/or sizes of particles may be ground in the spiral jet mill.

The ratio of pressurized gases relative to granular material may be selected to improve grinding capacity and/or energy efficiency. In some example configurations, the first and second streams comprise a ratio of input gas (e.g., input steam) to granular material (e.g., TiO2 piment particles) may be less than about 2:1, more preferably between about 1.1:1 and about 1.9:1, even more preferably about 1.5:1. For example, in some arrangements, the ratio of input gas to granular material in the streams may be about 1.54:1; however, other ratios are also contemplated.

In some configurations and methods, the spiral jet mill and/or method of the present invention may provide a more efficient system for reducing the particles sizes of granular materials in comparison to known spiral jet mills having only a single product injection nozzle. Other advantages, uses, and/or characteristics will become apparent upon review of the following detailed description and the drawings.

### BRIEF DESCRIPTION OF THE DRAWINGS

FIG. 1 is a side view a spiral jet mill according to certain aspects of the present invention with the cover shown in cross-section;

FIG. 2 is a top plan view of the spiral jet mill showing the cover; and

FIG. 3 is a cross-sectional detail view of product injector nozzle of the cover along the lines A-B of FIG. 2.

### DETAILED DESCRIPTION

The following description is meant to describe what is shown in the drawings and/or to various contemplated embodiments shown and/or related to what is shown in the drawings. Any of the features shown and/or described in relation to one embodiment may be combined with any one or more features shown and/or described relative to another embodiment. Any dimensions shown in the drawings are exemplary only and are not intended to limit the scope of the invention.

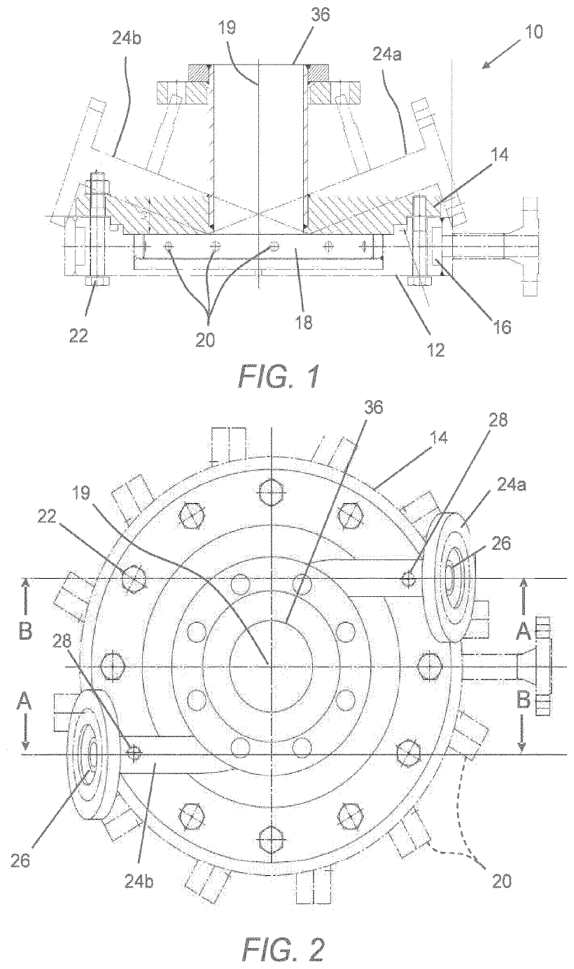

Turning now to the drawings, FIGS. 1-3 illustrate an example spiral jet mill 10 lid according to certain non-limiting aspects of the invention. The spiral jet mill 10 includes a mill body 12 and a cover 14. The mill body 12 includes a manifold 16 that surrounds and defines an outer periphery of a grinding chamber 18. In this example, the manifold 16 has a generally planar circular shape defining a circular grinding chamber 18 with a centerline 19, which in this example is defined by a vertical central axis, and having a height defined by the height of the manifold along the vertical central axis and a diameter extending through the vertical central axis and across the grinding chamber. Other shapes for the mill body 12 and the manifold 16 are possible, and the shapes need not be limited to circular shapes.

At least one, and in this example twelve, grind gas injector ports 20 extend through the manifold 16 to allow for injection of grinding material, such as steam or other compressed gas, into the grinding chamber 18. The manifold 16 may have more than twelve grind gas injector ports 20 or may have fewer than twelve gas injector ports. In another example, the manifold 16 has six grind gas injector ports 20. Preferably, the grind gas injector ports 20 are angularly spaced evenly around the periphery of the manifold 16. The grind gas injector ports 20 are oriented tangentially to the central axis to promote circumferential flow of gases and particulate matter inside the grinding chamber 18 in a single direction. In this example, each of the twelve rind gas injector ports 20 is oriented at an angle of between about 10° and about 20° (e.g., about 15°) from the radial direction so as to promote gas flow in a counterclockwise direction as viewed from the top; however, other orientations, such as other angles, different angles among the various grind gas injector ports 20, and/or orientation to promote flow in the clockwise and/or counterclockwise direction may be implemented. The mill body 12 may include other features, such as other grind gas inlets, grind gas outlets, a bottom wall, and/or additional features in any manner suitable for directing and/or exhausting grind gas into the grinding chamber 18.

The cover 14 is disposed on top of the mill body 12 so as to cover and enclose the grinding chamber 18. In this way, the cover 14 at least partially defines an upper surface of the grinding chamber 18. The cover 14 is preferably removably coupled to the mill body 12 in an operative position as shown in FIG. 1, for example with bolts 22 or other types of fasteners. Other mechanisms for attaching the cover 14 to the mill body 12 so as to enclose the grinding chamber 18 are also possible. The cover 14 in this example has the shape of a generally flat disc with stepped outer peripheral shoulders that are complementary to stepped inner peripheral shoulders in the top surface of the mill body 12. The cover 14 may have other shapes, such as a dome, closed ended cylinder, or other shape configured to promote flow of gases and product inside the grinding chamber 18 in a desired way.

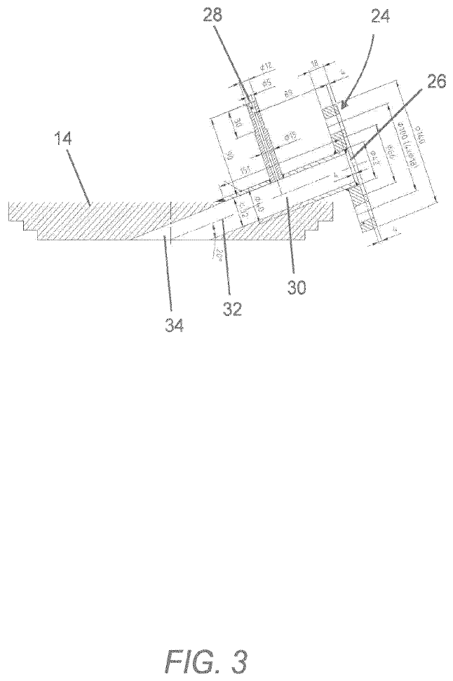

Unlike conventional spiral grinding mills, the spiral jet mill 10 includes at least two product injector nozzles 24, such as a first product injector nozzle 24a and a second product injector nozzle 24b, configured to inject streams of compressed gas, such as steam, and a granular product, such as titanium dioxide (TiO2) pigment particles, into the grinding chamber 18. In this example, the first and second product injector nozzles 24 are carried by and extend through the cover 14. However, in other examples, one or more of the product injector nozzles 24 ay extend through other parts of the spiral jet mill 10, such as through a floor of the grinding chamber 18 and/or through a sidewall of the grinding chamber, such as through the manifold 16. As best seen in FIG. 3, each product injector nozzle 24 extends downwardly at an acute angle relative to the horizontal plane of the cover 14 (as seen in reference to the drawings) into the grinding chamber 18.

As best seen in FIG. 2, each product injector nozzle 24 is oriented tangentially to the central axis of the grinding chamber 18 at an angle from the radius. Each product injector nozzle 24 thus tangentially oriented is offset from the central axis of the grinding chamber 18 and aligned to inject the respective first and second streams in the same clockwise or counterclockwise direction around the grinding chamber. Preferably each product injector nozzle 24 is offset the same distance from the central axis, although the product injector nozzles 24 may be offset different distances and/or oriented at different angles and/or in different directions relative to the central axis. In other arrangements, one or more of the product injector nozzles 24 may be oriented in different orientations, such as radially, in different clockwise or counterclockwise directions, and at different offsets or no offset from the central axis, to promote fluid flow in different patterns and/or collision of particles within the grinding chamber 18.

The first and second product injector nozzles 24a and 24b are arranged and oriented to form a pair of parallel product injector nozzles 24 aligned along parallel planes on opposite sides of the central vertical axis, each pointing in the opposite direction and offset on opposite sides of the central vertical axis so as to inject the respective streams of granular product and compressed gas in a counterclockwise direction similar to the grind gas injector ports 20.

The spiral jet mill 10 may include more than two product injector nozzles 24. For example, there may be three, four, or almost any number of product injector nozzles 24 with the only practical limitation being the physical space available to fit the product injector nozzles through the cover 14 and/or other locations through the mill body 12.

As best seen in FIG. 3, Each product Injector nozzle 24 may include a primary entry port 26 for gas and product and a secondary entry port 28 for a dosing substance. The secondary entry port 28 may be in the form of a smaller nipple and may be used for example for dosing other liquids, such as silicone oil, tri-methylpropane, or others, to provide a so-called organic coating of the particles which takes place during grinding in the mill. The primary entry port 26 and the secondary entry port 28 converge at a mixing chamber 30 where the stream of compressed gas and granular product can mix with any dosing substance that it is desired to mix into the stream. However, the secondary entry port 28 may be omitted and/or other ports may be included. A passageway 32 extending from the mixing chamber 30 into the grinding chamber 18 directs and injects the stream directly into the grinding chamber 18 through an injection end 34 of the product injector nozzle 24 that is disposed inside the grinding chamber and underneath the cover 14.

Although the first and second product injector nozzles 24a and 24b in this example are shown to be substantially identical, it is contemplated that any one or more of the product injector nozzles 24 may not be identical to each other but may be configured to provide different products and/or additives into the grinding chamber 18.

An exhaust port 36 allows ground particulate matter to exhaust out of the grinding chamber 18. In this example, the exhaust port 36 extends upwardly through the cover 14 and is aligned with the central axis of the grinding chamber when the cover 14 is operatively attached to the mill body 12 as shown in FIG. 1. The exhaust port 36 includes a generally cylindrical pipe section that is oriented generally vertically in the operative position and extends through the cover 14; however, other forms, shapes, and/or locations of the exhaust port 36 may be used. For example, the exhaust port 36 may also or alternatively extend downwardly through a bottom wall of the grinding chamber 18. The exhaust port 36 is preferably aligned with the central vertical axis so that smaller particles will migrate radially inwardly and eventually exhaust out of the grinding chamber 18 through the exhaust port(s) 36.

The spiral jet mill 10 may be used to mill a granular product, such as TiO2 pigment particles and/or other granular products, by simultaneously injecting a first stream of a mixture of input gas and granular product into the grinding chamber 18 through the first product injector nozzle 24a and injecting a second stream of a mixture of input gas and granular product into the grinding chamber through the second product injector nozzle 24b. Grinding material is also injected into the grinding chamber 18 through the grind gas injector port so as to impact and mill the granular product from the first and second streams into smaller particle sizes. The grinding material is preferably a pressurized gas, such as steam, air, and/or nitrogen, but may be or include other compressed gases, and/or other grinding materials, such hard grinding particles. The input gas is preferable steam but may be or include other compressed gases. Preferably, the first and second streams of input gas and granular product and the grinding material are all injected into the grinding chamber at the same time, although this may not be strictly necessary.

The ratio of total gas injected (e.g., input steam plus grinding steam) to granular product (e.g., TiO2 pigment particles) may be in a wide range. For example, the ratio of total gas injected to granular product may be between about 0.1:1 to 10:1, preferably between about of 0.2:1 to 5:1, and more preferably between about 0.5:1 to 3:1. In one preferred method, the ratio of total gas injected (e.g., input steam plus grinding steam) to granular product (e.g., TiO2 pigment particles) is approximately 1.5:1, e.g., 1.54:1, with the input gas being approximately 54% of the total gas (i.e., input gas plus grinding gas) injected into the grinding chamber per unit time. As seen from the examples detailed below, this total gas-to-TiO2 pigment input ratio (~1.5:1) provides an approximately 23% energy input savings in comparison to the conventional TiO2 jet milling techniques that use a total gas-to-TiO2 pigment input ratio of 2:1. However, the method and apparatus need not be limited to these particular ranges because it is expected that the energy efficiencies and throughput advantages of a multi-entry micronizer (spiral jet mill) as disclosed herein could be realized in a much larger range. In fact, the benefit will be higher the higher the actual ratio or standard ratio (total steam: product) with only one entry is. For example if the ratio of a conventional spiral jet mill having only a single entry (i.e., one product injector) is 5:1, and with a new spiral jet mill having double entry (i.e., two product injectors) the new spiral jet mill will be able to reduce the ratio of total input steam-to-total product input into the mill by about 25%, which will result in a ratio of 3.75:1 and a saving of 1.25 ton steam per ton of product. In comparison, for conventional (single product injector) spiral jet mill using a total steam: product ratio of 2:1 for milling TiO2 pigment particles, the same reduction of 25% when using a spiral jet mill with two product injectors results in a total steam: product ratio of 1.5 and a saving of 0.5 tons of steam per ton of product. For other types of granular products being milled, the conventional ratio of total gas input versus total granular product input may be different than for TiO2 particles.

However, the use of multiple nozzles to reduce the conventional total steam: product ratio a lower ratio in accordance with the concepts discussed herein would also be possible.

As shown hereinafter, use of a spiral jet mill with two (or more) nozzles in accordance with certain aspects of the invention can lead to significant energy savings in the grinding of TiO2 pigments for use in various end products. In the following examples, the required energy consumption for grinding a granular product, which in these examples is TiO2 pigment particles, consists primarily of the input steam and the grinding steam. If, instead of the one product injection nozzle of the conventional mill, one or more additional product injection nozzle are fed into the mill and the input of grinding steam is kept constant, there is a potential saving of the required energy requirement. Compared to a mill with only one product injection nozzle, there is a higher solids load, i.e., there are more particles per volume in the grinding chamber 18, which leads to an increased probability of particle-particle collisions and thus to a more efficient grinding. In addition, the total volume flow of granular product and input gas is increased by the additional input, which leads to increased speeds within the grinding chamber, and which in turn increases the effectiveness of the comminution. The increase in radial velocity also leads to a higher selectivity of the static viewing process, which prevents coarse material from leaving the mill when the mill is discharged.

Next, some investigations are described some non-limiting examples that illustrate certain, though not necessarily all, potential applications of the principles described above.

Baseline Example 1: In a first baseline comparative example, a conventional method of using a conventional spiral jet mill having a single product injection nozzle and fourteen grinding nozzles is considered. The spiral jet mill is operated with a throughput of four tons per hour of granular product to be milled (in this example, TiO2 pigment particles) at a total steam-to-pigment ratio of 2:1 with input steam being 54% of the combined input steam and grinding steam, i.e., input steam of 4320 kg/hour and grinding steam of 3680 kg/hour distributed over fourteen grinding nozzles. (Note, all tons in this and the following examples are metric tons =1000 kg).

Example 2: In a second example in accordance with certain aspects of the invention, a spiral jet mill with two product input nozzles (as described herein above) and fourteen grinding nozzles is considered. A double input of TiO2 pigment particles (granular product to be milled) and input steam, i.e., 8 ton/hour of product and input steam of 54% of the combined input steam and grinding steam, provides an input of 2×4320 kg/hour input steam=8640 kg/hour steam and 8 tons/hour of pigment plus 1×3680 kg/hour of grinding steam (total combined steam input of 12,320 kg/hour). This example leads to an energy saving of 3680 kg/hour of steam. In this example, the total steam-to-pigment ratio is 1.54:1 (instead of 2:1), which corresponds to an energy saving of 23% in direct comparison to baseline example 1 and a simultaneous increase of 100% of throughput capacity of granular product (e.g., the pigment) being milled.

Baseline Example 3: In a third baseline comparative example a conventional spiral jet mill with one product injection nozzle and six grinding nozzles is used. 130 kg/h pigment, 140 kg/h input steam, and 120 kg/h grinding steam distributed over 6 grinding nozzles is injected into the spiral jet mill. The total steam-to-pigment ratio is 2 tons of steam per 1 ton of pigment (i.e., 2:1).

Example 4: In a fourth example in accordance with certain aspects of the invention, a spiral jet mill with two product injection nozzles (as described herein above) and six grinding nozzles is used. A double input of pigment and input steam is used, i.e., 2×130 kg/hour=260 kg/hour of product, 2×140 kg/h input steam, plus 1×120 kg/h grinding steam=400 kg/hour total steam throughput. This example leads to an energy saving of 120 kg/h steam, where the total steam-to-pigment ratio is 1.54:1 (instead of 2:1). This corresponds to an energy saving of 23% compared to baseline example 3 with a simultaneous capacity increase of 100%.

From these examples, it can be seen that a spiral jet mill with two or more product injection nozzles can provide a significant energy savings over conventional grinding mills, as well as increase product throughput, in a way not previously considered. As such, a spiral jet mill and operation of such a mill in accordance with certain aspects of the invention may also provide a more energy efficient way to grind TiO2 pigment particles and other granular products.

1. A spiral jet mill (10) comprising:
a manifold (16) surrounding and at least partly defining a grinding chamber (18);
a grind gas injector port (20) extending through the manifold into the grinding chamber for injecting grinding material into the grinding chamber;
a cover (14) over the manifold, the cover at least partly defining the grinding chamber;
an exhaust port (36) for exhausting ground product from the grinding chamber; and
a first product injector nozzle (24a) directed into the grinding chamber and configured to mix and inject a first stream of input gas and a granular product into the grinding chamber;
wherein the steam jet mill further comprises
a second product injector nozzle (24b) directed into the grinding chamber for mixing and injecting a second stream of input gas and the granular product into the grinding chamber.

2. The spiral jet mill (10) of claim 1, wherein at least one of the first and second product injector nozzles (24a, 24b) extends through the cover (14).

3. The spiral jet mill (10) of claim 1, wherein each of the first and second product injector nozzles (24a, 24b) extends through the cover (14).

4. The spiral jet mill of claim 1, wherein each of the first product injector nozzle (24a) and the second product injector nozzle (24b) is aligned tangentially to and offset from a centerline (19) of the grinding chamber (18).

5. The spiral jet mill of claim 1, wherein each of the first product injector nozzle (24a) and the second product injector nozzle (24b) is aligned to inject the respective first and second streams in the same clockwise or counterclockwise direction around the grinding chamber (18).

6. The spiral jet mill of claim 1, wherein the first product injector nozzle (24a) is aligned parallel to the second product injector nozzle (24b).

7. The spiral jet mill of claim 4, wherein the first product injector nozzle (24a) and the second product injector nozzle (24b) are disposed on opposite sides of the centerline (19).

8. The spiral jet mill of claim 4, wherein each of the first product injector nozzle (24a) and the second product injector nozzle (24b) has an injection end (34) inside the grinding chamber (18), wherein the injection end of each of the first product injector nozzle and the second product injector nozzle is located the same radial distance from the centerline (19).

9. The spiral jet mill of claim 1, further comprising a third product injector (24) nozzle directed into the grinding chamber (18) configured to mix and inject a third stream of input gas and the granular product into the grinding chamber.

10. A method of milling a granular product using the spiral jet mill of claim 1, the method comprising:
simultaneously injecting the first stream of a mixture of input gas and granular product into the grinding chamber (18) through the first product injector nozzle (24a) and injecting the second stream of a mixture of input gas and granular product into the grinding chamber through the second product injector nozzle (24b);
injecting grinding material into the grinding chamber through the grind gas injector port (20) so as to impact and mill the granular product from the first and second streams into smaller particle sizes.

11. The method of claim 10, wherein the input gas comprises input steam.

12. The method of claim 10, wherein the granular product comprises TiO₂ pigment particles.

13. The method of claim 10, wherein the grinding material comprises pressurized gas.

14. The method of claim 13, wherein the pressurized gas comprises at least one of grinding steam, air, and/or nitrogen,

15. The method of claim 10, wherein the first and second streams and the grinding material have a ratio of total input gas and grinding material to granular product between about 0.1:1 to 10:1.

16. The method of claim 10, wherein the granular product comprises TiO₂ pigment particles, the input gas comprises steam, and the grinding material comprises steam, and wherein the first and second streams and the grinding material have a ratio of total steam to TiO₂ pigment particles less than about 2:1.
